(19) United States
(12) Patent Application Publication
(10) Pub. No.: US 2009/0046794 A1
(43) Pub. Date: Feb. 19, 2009

(54) MULTI-INPUT MULTI-OUTPUT COMMUNICATION DEVICE, ANTENNA DEVICE AND COMMUNICATION SYSTEM

(75) Inventors: Jun MARUYAMA, Aichi (JP); Nagahiro MATSUURA, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Buffalo Inc., Nagoya-shi (JP)

(21) Appl. No.: 12/179,110

(22) Filed: Jul. 24, 2008

(30) Foreign Application Priority Data
Jul. 25, 2007 (JP) 2007-192767
Jul. 17, 2008 (JP) 2008-185457

(51) Int. Cl. H04L 27/28; H01Q 9/04; H01Q 19/30

(52) U.S. Cl. 375/260; 343/700 MS; 343/819

(57) ABSTRACT

A multi-input multi-output communication device can communicate with other communication device. The multi-input multi-output communication device includes: an antenna device configured to perform communication using a plurality of polarized waves; a transmitting circuit configured to divide data to be transmitted into a plurality of data streams, and transmit the data by multiplexing signals corresponding to the data streams on the plurality of polarized waves from the antenna device; and a receiving circuit configured to receive data by separating signals multiplexed at the other communication device from a signal received by the antenna device via the plurality of polarized waves.

### CROSS-REFERENCE TO RELATED APPLICATIONS

This application is based upon and claims the benefit of priority from Japanese Patent Application No. 2007-192767 filed on Jul. 25, 2007 and No. 2008-185457 filed on Jul. 17, 2008, the entire contents of which are incorporated herein by reference.

### TECHNICAL FIELD

The present invention relates to a multi-input multi-output communication device, an antenna device used therein and a communication system therewith.

### BACKGROUND

Recently, a wireless LAN is being widely used in many places such as a personal house, an office, public facilities. When the wireless LAN is used in a building, various obstacles are present between a terminal device and an access point and hence a good communication state may not be always maintained. In addition, a plurality of terminal devices may access one access point.

In this case, the effective speed of the wireless LAN is significantly degraded in a single-input single output (SISO) or single-input multi-output (SIMO) communication system. In general, communication speed may be raised by using a wide frequency band. However, it is difficult to simply widen a bandwidth since an available band is assigned to the wireless LAN. In view of the circumstances, new communication systems are proposed, which provides a plurality of antennas and transmit and receive different data on the same frequency band. One of the communication systems is called a Space Division Multiplexing system, which is generally called a multi-input multi-output (MIMO) communication system. JP-A-2005-45351 discloses a communication device of MIMO communication system.

In the MIMO communication system, each of a transmitter and a receiver includes a plurality of antennas. From the theory of space division multiplexing communication, the relationship of between each of antennas of the transmitter and each of antennas of the receiver needs to be different. For this reason, a predetermined separation distance should be secured between the antennas of the transmitter or the receiver. Accordingly, a device size may be increased. When the distance between the transmitter and the receiver increases, the increase of the device size may not be ignored, since a relative difference of spatial states of antennas between the transmitter and the receiver is small as a communication distance increases. As a result, a distance between antennas of each of the receiving side and the transmitting side should be widely made when the communication distance extends, which leads to an increase in a size of the communication device.

Instead of the above technique resulting in the increase of the device size, there is proposed a technique for improving a communication distance and speed by dynamically controlling an arrival range and directivity of radio waves using a beamforming technique. However, this may not be a practical solution, since it is necessary to provide complicated software for dynamically controlling the arrival distance and directivity of radio waves.

### SUMMARY

In view of the disadvantages of the above-described background, one aspect of the present invention has an object to provide a reduced-sized antenna device without degrading communication performance in a multi-input multi-output communication device, and the reduced-sized multi-input multi-output communication device itself.

According to an aspect of the invention, there is provided a multi-input multi-output communication device capable of communicating with other communication device, said multi-input multi-output communication device comprising: an antenna device configured to perform communication using a plurality of polarized waves; a transmitting circuit configured to divide data to be transmitted into a plurality of data streams, and transmit the data by multiplexing signals corresponding to the data streams on the plurality of polarized waves from the antenna device; and a receiving circuit configured to receive data by separating signals multiplexed at the other communication device from a signal received by the antenna device via the plurality of polarized waves.

According to another aspect of the invention, there is provided a patch-type orthogonal antenna device for use in at least one of a terminal device and an access point in a wireless LAN for performing wireless communication in a multi-input multi-output system, said antenna device comprising: a plate-shaped ground plate; a plate-shaped driven element provided to be spaced by a predetermined distance from the ground plate; and power receiving and feeding terminals configured to receive and feed power and provided at different positions on phases of the driven element.

According to still another aspect of the invention, there is provided a Yagi-type orthogonal antenna device for use in at least one of a terminal device and an access point in a wireless LAN for performing wireless communication in a multi-input multi-output system, said antenna device comprising: a first Yagi-Uda antenna comprising a reflector element, a driven element, and a director element arranged in order from a rear end side; a second Yagi-Uda antenna that comprises a reflector element, a driven element, and a director element arranged in order from a rear end side, has the same directional direction as the first Yagi-Uda antenna and is arranged to be rotated by a predetermined angle with respect to an axis in the directional direction; and power feeding lines configured to feed power to each of the driven elements of the first and second Yagi-Uda antennas.

According to still another aspect of the invention, there is provided a communication system for a multi-input multi-output system, comprising: a transmitter; and a receiver, wherein the transmitter comprises: a first antenna device configured to perform transmission using a plurality of polarized waves; and a transmitting circuit configured to divide data to be transmitted into a plurality of data streams, and transmit the data by multiplexing signals corresponding to the data streams on the plurality of polarized waves from the first antenna device, and wherein the receiver comprises: a second antenna device configured to perform reception using a plurality of polarized waves; and a receiving circuit configured to receive the data by separating signals multiplexed at the transmitter from a signal received by the second antenna device via the plurality of polarized waves.

### BRIEF DESCRIPTION OF THE DRAWINGS

FIG. 1 is an illustrative diagram showing a schematic structure of a wireless LAN system having an antenna device as an embodiment of the present invention;

FIG. 2 is an illustrative diagram showing the external appearance of an access point of a first embodiment;

FIG. 3 is an illustrative diagram showing the external appearance of a terminal device and an antenna device of the first embodiment;

FIG. 4 is an illustrative diagram showing the external appearance of an antenna device;

FIG. 5 is an illustrative diagram showing an antenna device of a second embodiment;

FIG. 6 is an illustrative diagram showing a modified example of the second embodiment;

FIG. 7 is an illustrative diagram showing a schematic structure of Yagi-Uda antennas configuring an antenna device of the modified example; and

FIG. 8 is an illustrative diagram showing an access point capable of performing transmission and reception of the embodiment.

### DESCRIPTION

### First Embodiment

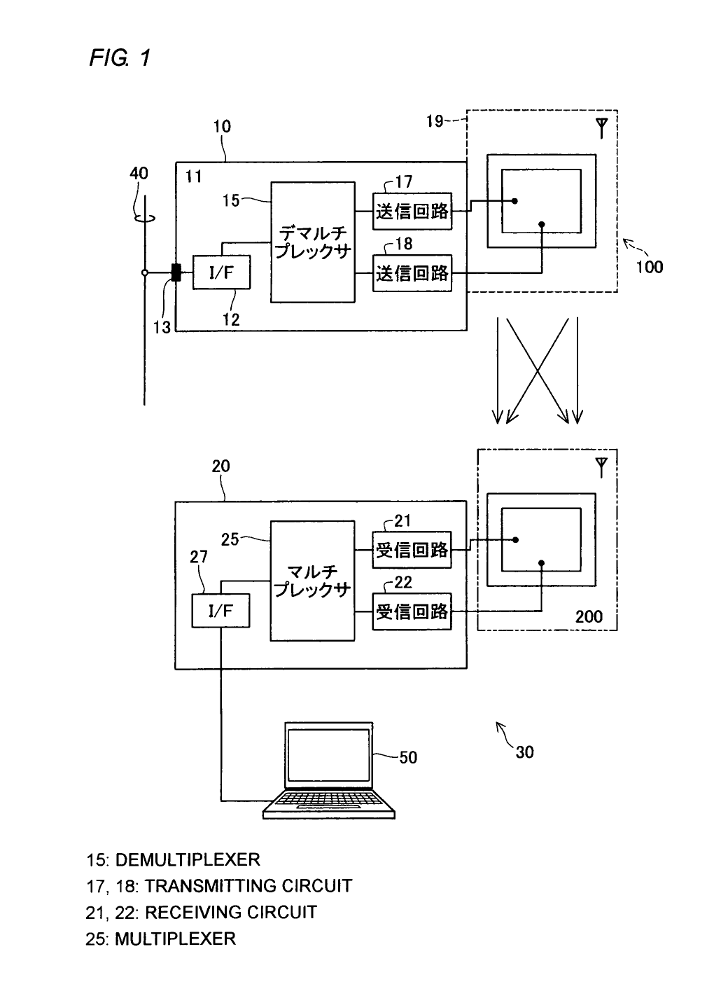

Hereinafter, embodiments of the present invention will be described. FIG. 1 is an illustrative diagram showing a wireless LAN (Local Area Network) system 30 having an access point 10 and a terminal device 20 according to an embodiment of the present invention. The access point 10 is connectable to a WAN (Wide Area Network) 40 such as the Internet through a wired link and capable of communicating with the terminal device 20 through a wireless link. The access point 10 is configured to output a request from a computer 50 connected to the terminal device 20 to the WAN 40 side, and output data returned from the WAN 40 side to the requesting terminal device 20 side through the wireless LAN. An example of the protocol used in the communication among the WAN 40, the access point 10, and the terminal device 20 is TCP/IP protocol in this embodiment, but other protocols may be used.

The access point 10 includes: an interface (I/F) 12 for the WAN 40; a demultiplexer 15 configured to divide data received from the WAN 40 through the interface 12 into two data streams; and two transmitting circuits 17 and 18 configured to respectively transmit two series of signals corresponding to divided data streams, which are provided in a housing 11. Output sides of the transmitting circuits 17 and 18 are connected to an antenna device 100 attached to the housing 11, and the data to be transmitted to the terminal device 20 is transmitted through the antenna device 100 by wireless communication. A detailed structure of the antenna device 100 will be described later.

The terminal device 20 is connected to an antenna device 200 independently provided and includes: two receiving circuits 21 and 22 to which two series of signals received by the antenna device 200 are respectively input; a multiplexer 25 configured to combining data received and output by the receiving circuits 21 and 22; and an interface (I/F) 27 through which the data combined and output by the multiplexer 25 is allowed to be exchanged with the computer 50.

In the above description for simplification thereof, it has been assumed that the access point 10 only outputs data from the WAN 40 side through the antenna device 100, and the terminal device 20 only outputs data received through the wireless LAN from the access point 10 to the computer 50 side. Of course, in practice, the access point 10 also receives data from the terminal device 20, and the terminal device 20 also transmits data to the access point 10. Accordingly, the access point 10 and the terminal device 20 are respectively additionally provided with the above-described receiving-side circuit and the above-described transmitting-side circuit embedded into the counterpart devices.

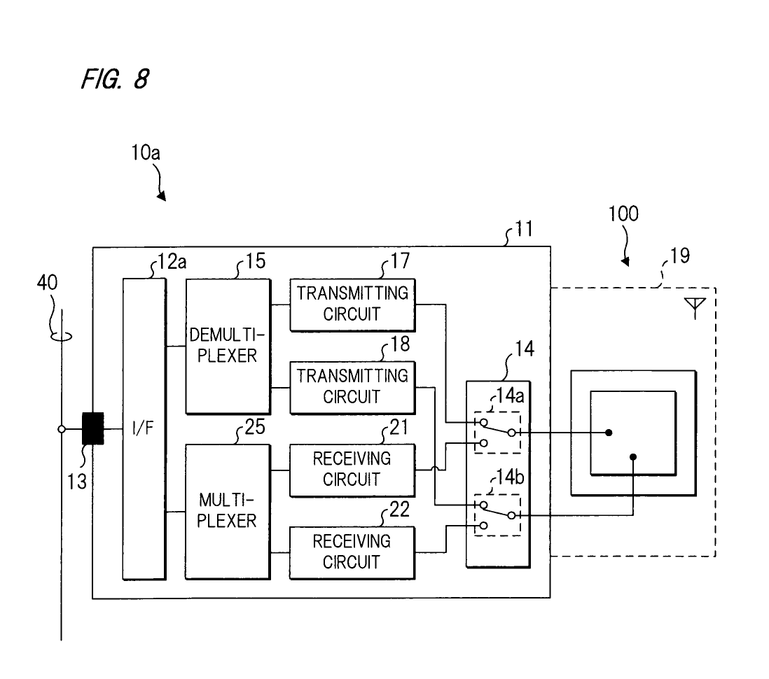

FIG. 8 is an illustrative diagram showing an access point 10a capable of performing both transmission and reception of the embodiment. In FIG. 8, regarding elements in the access point 10a which have similar functions to those shown in FIG. 1, the same symbols are assigned and a detailed description thereof is omitted. A terminal device capable of performing both transmission and reception includes similar elements.

As shown in FIG. 8, the access point 10a includes: an interface (I/F) 12a; the demultiplexer 15; the transmitting circuits 17 and 18; the multiplexer 25; the receiving circuits 21 and 22; a switching unit 14; and the antenna device 100.

The antenna device 100 is capable of transmitting the wireless signals respectively corresponding to two series of signals output from the transmitting circuits 17 and 18 and is also capable of receiving two series of wireless signals and output the received signals to the receiving circuits 21 and 22, respectively.

The switching unit 14 includes a first switching portion 14a and a second switching portion 14b. The first switching portion 14a connects one feeding point of the antenna device 100 to the transmitting circuit 17 or the receiving circuit 21. The second switching portion 14b connects the other feeding point of the antenna device 100 to one of the transmitting circuit 18 or the receiving circuit 22. The first switching portion 14a and the second switching portion 14b are controlled to synchronously select the transmitting circuits 17 and 18 during the transmission and to select the receiving circuits 21 and 2 during the reception. That is, the switching unit 14 is configured to select one of: a connection between the antenna device 100 and the transmitting circuits 17, 18; and a connection between the antenna device 100 and the receiving circuits 21, 22.

The interface 12a is located between the WAN 40 and the demultiplexer 15 and the multiplexer 25 and configured to output data from the WAN 40 to the demultiplexer 15 and output data from the multiplexer 25 to the WAN 40.

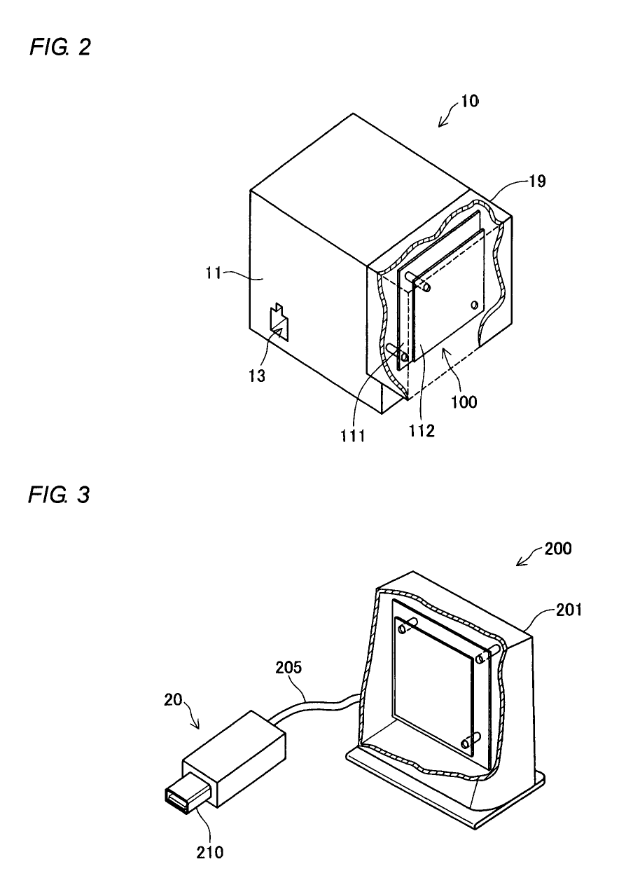

FIG. 2 is an illustrative diagram showing the external appearance of the access point 10. As shown in FIG. 2, the access point 10 includes: a connector 13 that allows a cable for a connection with the WAN 40 to be attached to the housing 11; and a plastic cover 19 for covering the antenna device 100. For a better understanding, in FIG. 2, a cut-away section of the cover 19 is shown. In this embodiment, the antenna device 100 is covered with the cover 19, but can be mounted to the access point 10 in an exposed state.

The access point 10 is generally connected through a modem (not shown), but if the access point 10 has a function to access with the WAN, the access point 10 may directly access to the WAN 40 side. The modem may be connected to an optical cable connected to an Internet network, a coaxial cable used for transmission and reception of a cable TV, or an ADSL metal cable and modulates, and is configured to modulate/demodulate a signal between the cable and the access point 10.

FIG. 3 shows the external appearance of the terminal device 20 and the antenna device 200 thereof. As shown in FIG. 3, the antenna device 200 is provided in an external attachment type for the terminal device 20. The antenna device 200 is accommodated in an independent housing 201. The terminal device 20 is configured in a form for being inserted into an IC card slot of the computer 50. The terminal device 20 can be configured in a form for being connected to a connector of an IEEE 1394 specification or a USB port. Alternatively, a function of the terminal device 20 may be pre-embedded into the computer 50. In this case, the antenna device 200 may be pre-mounted in the computer 50, or only the antenna device 200 may be externally attached.

At the access point 10, the antenna device 100 is covered with the cover 19 and is attached to the housing 11 of the access point 10. At the terminal device 20, the antenna device 200 is accommodated in the independent housing 201. The terminal device 20 is connectable to the antenna device 200 by a dedicated cable 205. A USB connector 210 is provided in the terminal device 20. The terminal device 20 is directly connected to the computer 50 using the USB connector 210. When the terminal device 20 is connected to the USB connector of the computer 50, the terminal device 20 functions as a slave when viewed from the computer 50.

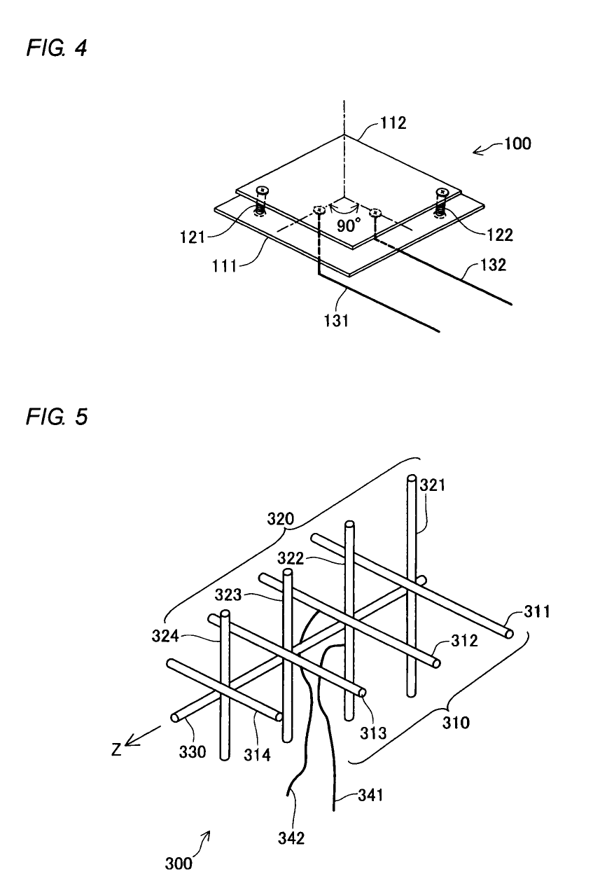

The two antenna devices 100 and 200 have different accommodation forms, but have the same structure. In this embodiment, the structure of the antenna device 100 at the access point 10 will be described. The external appearance of the antenna device 100 is shown in FIG. 4. A difference is present between an embedded type and an external attachment type, but the antenna device 200 basically has the same form. The antenna device 100 (200) is an orthogonal antenna in which two metal plates 111 and 112 of the antenna device 100 (200) are spaced by a predetermined distance d or a so-called patch-type antenna. The orthogonal antenna is defined as an antenna capable of transmitting radio waves which have respectively different polarization planes such that the polarized waves do not interfere one another. Therefore, when a plurality of polarized waves are used for the radio communication, the orthogonal antenna allows the antenna device 100 (200) to be configured by only one antenna element, which can reduce the size of the antenna device 100 (200). When a frequency of radio waves used in the wireless LAN is 2.4 GHz, the larger plate 111 of the two metal plates 111 and 112 has a size of about 70 mm×70 mm, and the smaller plate 112 has a size of about 50 mm×50 mm. The distance d between the two plates is set to about 10 mm. The metal plate 111 functions as a ground plate, and the metal plate 112 functions as a driven element. The two plates 111 and 112 are fixed by insulation supports 121 and 122. The antenna device 100 is fixed by an insulation support and attached to a side face of the housing 11. The antenna device 200 is fixed by an insulation support and attached to an inner side face of the housing 201.

Power receiving and feeding lines 131 and 132 for feeding power (and receiving power upon reception) are connected to the plate 112 of the antenna device 100 (200). The power receiving and feeding line 131 is used to couple an output from the transmitting circuit 17 (the receiving circuit 21) to the plate 112 of the antenna device 100 (200). The power receiving and feeding line 132 is used to couple an output from the transmitting circuit 18 (the receiving circuit 22) to the plate 112 of the antenna device 100 (200). Connection positions of the plate 112 of the two power receiving and feeding lines 131 and 132 are exactly deviated by 90 degrees within surfaces of the plate 112 when viewed from the center of the antenna device 100 (200). Thus, radio waves radiated from the plate 112 of the antenna device 100 (200) are made by exactly rotating polarization planes by 90 degrees.

The radio waves radiated from the plate 112 of the antenna device 100 have the same frequency band of 2.4 GHz, but the polarization planes are deviated. Accordingly, signals output from the two transmitting circuits 17 and 18 are radiated by two polarized waves from the antenna device 100. The radio waves whose polarization planes are deviated can be easily distinguished even when a distance to the counterpart antenna device 200 is relatively large. Since the counterpart antenna device 200 also has a structure configured with the same plates 111 and 112, two polarized waves radiated from the antenna device 100 can be received, and electric signals are induced on the plate 112 serving as the driven element. The electric signals from the plate serving as the driven element are respectively output to the two receiving circuits 21 and 22 of the terminal device 20.

The access point 10 and the terminal device 20 configuring the wireless LAN system 30 have a function for transmitting and receiving a multiplexed signal by a so-called MIMO system. Many systems for transmitting and receiving the multiplexed signal are well known, but this embodiment has specifically adopted multi-input multi-output orthogonal frequency division multiplexing (MIMO-OFDM) system. Of course, multi-input multi-output space division multiplexing (MIMO-SDM) system or other systems can be adopted. In the other systems, the receiving circuits 21 and 22 can have a circuit structure for separating a plurality of data streams from a received signal by multiplying the receiving signal by a predetermined reception weight. The transmitting circuits 17 and 18 and the receiving circuits 21 and 22 can perform a unique mode transfer for transmission and reception by sharing information regarding transfer paths. Alternatively, the transmitting circuits 17 and 18 may include a circuit for coding the data in a space-time domain by pre-processing data to be multiplexed, and the receiving circuits 21 and 22 may separate the signals from the received signal using a decoding method corresponding to a coding method of the transmitting circuits 17 and 18. The coding method may use one of a space-time block code (STBC) and a space-time trellis code (STTC).

In this embodiment, at the antenna device 100 (200), the connection positions of the plate 112 of the power receiving and feeding lines 131 and 132 are deviated by 90 degrees, and the polarization planes are orthogonal. Alternatively, the antenna device 100 (200) may transmit and/or receive the radio waves through three or more polarized waves with different polarization planes. For example, when three polarized waves are used for the communication, the plate 112 has a circular shape, and three power receiving and feeding lines are connected to three connection positions provided on the circular-shaped plate 112 which are deviated by 60 degrees. When the number of polarized waves is N (N>2), the separation between polarized waves can be facilitated if the connection positions of the power receiving and feeding lines are deviated by 180 degrees/N.

In the wireless LAN system 30 having the above-described structure, the access point 10 and the terminal device 20 transmits and receives a multiplexed signal using the MIMO system. At this time, different paths are secured using different polarization planes of radio waves radiated from the antenna device without securing different paths on wireless communication using a positional difference. Thus, even when a distance of the access point 10 and the terminal device 20 is large, there is no case where the difference of paths on wireless communication is not maintained due to distance. As a result, there is an advantage in that the communication distance can extend, and high communication speed can be sufficiently maintained. Since the patch-type orthogonal antenna is adopted, the antenna itself does not need to be projected from the housing 11 in order to secure the distance between the antennas. Thus, the antenna device 100 can be accommodated in the housing 11 of the access point 10. Of course, the antenna device 100 can be separated from the housing 11 of the access point 10 like the antenna device 200 of the terminal device 20 side.

### Second Embodiment

Next, a second embodiment of the present invention will be described. An antenna device 300 of the second embodiment is used in the same wireless LAN system as that of the first embodiment, and is used in place of the antenna devices 100 and 200 of the first embodiment. The structure of the wireless LAN system is the same as that of the first embodiment. FIG. 5 is a perspective view showing the external appearance of the antenna device 300. The antenna device 300 is a type of orthogonal antenna and adopts a Yagi-type structure. That is, the antenna device 300 includes a first Yagi-Uda antenna 310 and a second Yagi-Uda antenna 320 having the same directional direction Z as the first Yagi-Uda antenna 310 and placed at a position rotated by 90 degrees with respect to an axis in the directional direction Z. The first Yagi-Uda antenna 310 includes a reflector element 311, a driven element 312, and director elements 313 and 314, which are formed by metal poles in order from a rear side of a radiation direction of radio waves. The reflector element 311, the driven element 312, and the director elements 313 and 314 are attached to a support 330 and fixed.

The antenna device 300 is designed for use in a 2.4 GHz band. The length of each of the reflector element 311, the driven element 312, and the director elements 313 and 314 is about 100 mm to 125 mm. A distance from the reflector element 311 to the director element 313 is about 120 mm. On the other hand, the second Yagi-Uda antenna 320 includes a reflector element 321, a driven element 322, and director elements 323 and 324. The reflector element 321, the driven element 322, and the director elements 323 and 324 are attached to the support 330 and fixed. The length or interval of each of the reflector element 321, the driven element 322, and the director elements 323 and 324 of the second Yagi-Uda antenna 320 is the same as that of the first Yagi-Uda antenna 310 in that a frequency band of used radio waves is the same as that of the first Yagi-Uda antenna 310. Power receiving and feeding lines 341 and 342 for receiving and feeding power from a transmitting circuit or a receiving circuit are respectively connected to the driven elements of the first and second Yagi-Uda antennas 310 and 320.

As described above, the antenna device 300 of the second embodiment adopts the first and second Yagi-Uda antennas 310 and 320 rotated by 90 degrees around the axis to which the directional direction Z is set. Accordingly, multiplexed communication between an access point and a terminal device of the wireless LAN system can be performed by MIMO-OFDM using the Yagi-Uda antennas 310 and 320. In the access point and the terminal device using the antenna device 300, different paths on wireless communication are secured using different polarization planes of radio waves in the two Yagi-Uda antennas 310 and 320. Thus, even when a distance of the access point 10 and the terminal device 20 is large, there is no case where the difference of paths on wireless communication is not maintained due to distance. As a result, there is an advantage in that the communication distance can extend, and high communication speed can be sufficiently maintained. In addition, since the Yagi-Uda antenna inherently have very high directivity, and a distance of multiplexed communication between the access point and the terminal can be extended. In this embodiment, two Yagi-Uda antennas are combined, but more than two Yagi-Uda antennas can be combined. When N Yagi-Uda antennas are combined, angles of the antennas need to be deviated by 180/N degrees by setting the directional direction Z to the axis.

### Modified Example

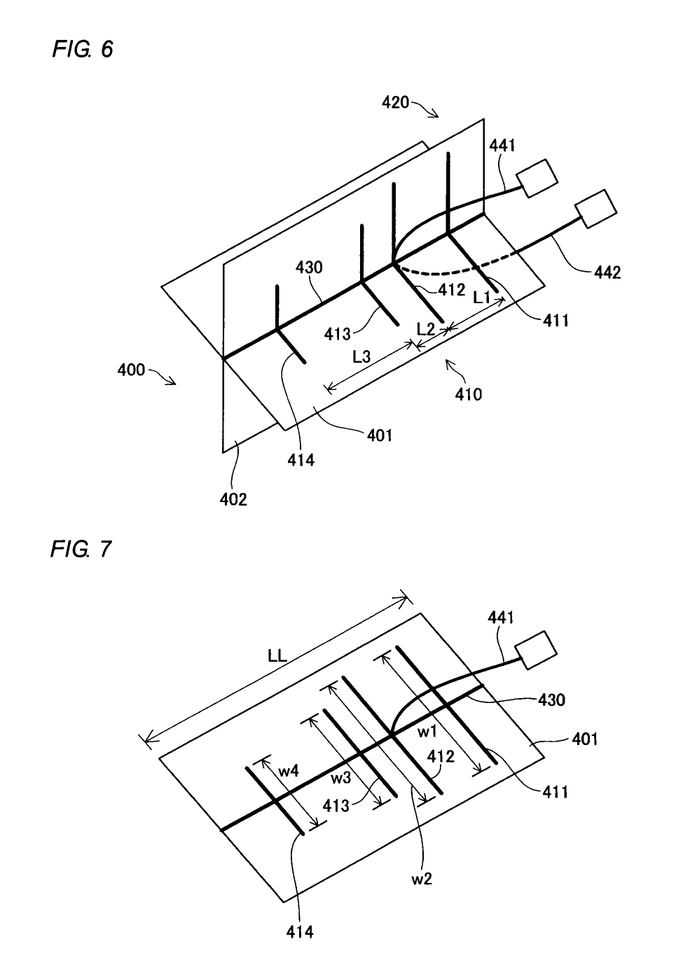

A modified example of the second embodiment will be described. FIG. 6 is an illustrative diagram showing an antenna device 400 as the modified example of the second embodiment. In the antenna device 400, two Yagi-Uda antennas are formed by conductors on a substrate having a high dielectric constant. As shown in FIG. 6, first and second Yagi-Uda antennas 410 and 420 of the antenna device 400 are antennas substantially having the same shape, and the shape is shown in FIG. 7. As shown in FIG. 7, the first Yagi-Uda antenna 410 includes a reflector element 411, a driven element 412, and director elements 413 and 414, which are formed by patterning metal conductors in order from a rear side of a radiation direction of radio waves on a dielectric substrate having a dielectric constant of 4. A power feeding line 441 is connected to the driven element 412. A conductor pattern 430 is provided on the center of the reflector element 411, the driven element 412, and the director elements 413 and 414. However, the omission of the conductor pattern 430 does not affect the performance of the antenna device 400, since an electric field is 0 like as the support 330 of the first embodiment (see FIG. 5).

Since the first Yagi-Uda antenna 410 is provided on a dielectric having a dielectric constant of 4, its shape is significantly miniaturized. That is, a width W1 of the reflector element 411 can be set to about 50 mm, a width W2 of the driven element 412 can be set to about 50 mm, and widths W3 and W4 of the director elements 413 and 414 can be set to 40 mm and 35 mm, respectively. A distance L1 between the reflector element 411 and the driven element 412 is about 20 mm, a distance L2 between the driven element 412 and the director element 413 is about 10 mm, and a distance L3 between the two director elements 413 and 414 is about 30 mm. A total length LL of a substrate 401 is accommodated within only 80 mm.

The second Yagi-Uda antenna 420 also basically has the same shape. A power feeding line 442 is connected to the driven element. The two antennas 410 and 420 are provided from intercepts at different directions toward the center of the antennas 410 and 420. Two substrates 401 and 402 are combined and unified as the antenna device 400. Since the two substrates 401 and 402 are vertically combined, polarization planes of the two Yagi-Uda antennas 410 and 420 are rotated by 90 degrees with respect to the axis in the directional direction Z.

Since the substrates 401 and 402 having a high dielectric constant are used in the antenna device 400 of this modified example, the Yagi-Uda antennas 410 and 420 can be further miniaturized as compared to the second embodiment. When FIGS. 5 and 6 are actually compared, a relative size is set to about ⅓ to about ½, thereby achieving the miniaturization of the entire shape. Furthermore, a distance between two antennas does not need to be excessively extended in order to extend a communication distance. Accordingly, a reduced-sized compact access point of wireless LAN and a reduced-sized compact terminal device communicating therewith can be easily provided. Since a conductor pattern is formed on a substrate having a high dielectric constant, the cost and process required to manufacture the antenna device 400 can be reduced.

Several embodiments have been described above, but the present invention is not limited thereto. Of course, various types of aspects are possible in a range without departing from the scope of the invention. For example, the present invention is not limited to orthogonal antennas of linear polarizations, and a combination of an antenna of which a polarization plane is rotated to the right and an antenna of which a polarization plane is rotated to the left can be used. Use in a frequency band other than 2.4 GHz is possible.

According to the embodiments of the invention, the following aspects are provided.

(First Aspect)

A multi-input multi-output communication device of the first aspect can communicate with other communication device. The multi-input multi-output communication device including: an antenna device configured to perform communication using a plurality of polarized waves; a transmitting circuit configured to divide data to be transmitted into a plurality of data streams, and transmit the data by multiplexing signals corresponding to the data streams on the plurality of polarized waves from the antenna device; and a receiving circuit configured to receive data by separating signals multiplexed at the other communication device from a signal received by the antenna device via the plurality of polarized waves.

In this multi-input multi-output communication device, a plurality of polarized waves are used for communication between a transmitter side and a receiver side. As a result, multi-input multi-output communication with a reduced-sized antenna device can be easily realized.

Here, the antenna devices may include an orthogonal antenna. When at least one of first and second antenna devices is an orthogonal antenna, multi-input multi-output communication may be easily realized using the plurality of polarized waves in a state in which one antenna device as the orthogonal antenna is miniaturized. The orthogonal antenna is defined as an antenna capable of transmitting radio waves which have respectively different polarization planes such that the polarized waves do not interfere one another. The orthogonal antenna may be a patch-type orthogonal antenna including a rectangle-shaped ground plate, a rectangle or circular shaped driven element provided to be spaced by a predetermined distance from the ground plate, and power receiving and feeding terminals configured to receive and feed power and provided at different positions on phases of the driven element. The patch-type orthogonal antenna may be easily miniaturized. Since the antenna is planar, a distance between antennas does not need to be widely made, such that the antenna may be easily mounted in equipment such as a wireless LAN terminal device or access point.

The orthogonal antenna may be a Yagi-type orthogonal antenna device including: a first Yagi-Uda antenna that includes a reflector element, a driven element, and a director element arranged in order from a rear end side; a second Yagi-Uda antenna that includes a reflector element, a driven element, and a director element arranged in order from a rear end side, has the same directional direction as the first Yagi-Uda antenna and is arranged to be rotated by a predetermined angle with respect to an axis in the directional direction; and a power feeding line configured to feed power to each driven element of the first and second Yagi-Uda antennas. The Yagi-Uda antenna capable of realizing very high directivity is suitable for performing multi-input multi-output communication between a transmitter side and a receiver side away from each other.

In the multi-input multi-output communication device, the receiving circuit may include a circuit configured to separate a plurality of data streams from the received signal by multiplying the received signal by a predetermined reception weight. In this structure, the transmitter side does not need to have information regarding a transfer path. On the other hand, the transmitter side and the receiver side may perform a unique mode transfer for transmission and reception by sharing information regarding a transfer path. In this case, a high communication characteristic can be realized since the information regarding the transfer path is shared.

In the above-described multi-input multi-output communication device, for example, the transmitting circuit of the transmitter may include a circuit configured to code the data in a space-time domain by pre-processing data to be multiplexed, and the receiving circuit of the receiver may separate the signals from the received signal using a decoding method corresponding to a coding method of the transmitting circuit. When the coding operation is performed in the space-time domain, the reliability of communication may be raised.

The coding method may use one of a space-time block code (STBC) and a space-time trellis code (STTC). By this coding method, a high gain may be realized.

(Second Aspect)

A patch-type orthogonal antenna device of the second aspect is for use in at least one of a terminal device and an access point in a wireless LAN for performing wireless communication in a multi-input multi-output system. The patch-type orthogonal antenna device includes: a rectangle-shaped ground plate; a rectangle or circular shaped driven element provided to be spaced by a predetermined distance from the ground plate; and power receiving and feeding terminals configured to receive and feed power and provided at different positions on phases of the driven element.

Multi-input multi-output communication using the wireless LAN between the terminal device and the access point may be performed using this antenna device and the antenna device may be miniaturized.

(Third Aspect)

A Yagi-type orthogonal antenna device of the third aspect is for use in at least one of a terminal device and an access point in a wireless LAN for performing wireless communication in a multi-input multi-output system. The Yagi-type orthogonal antenna includes: a first Yagi-Uda antenna including a reflector element, a driven element, and a director element arranged in order from a rear end side; a second Yagi-Uda antenna that includes a reflector element, a driven element, and a director element arranged in order from a rear end side, has the same directional direction as the first Yagi-Uda antenna, and is arranged to be rotated by a predetermined angle with respect to an axis in the directional direction; and a power feeding line configured to feed power to each driven element of the first and second Yagi-Uda antennas.

By using the antenna device, multi-input multi-output communication using the wireless LAN between the terminal device and the access point can be performed, and a communication distance between the terminal device and the access point can be extended due to high directivity of the antenna device.

(Fourth Aspect)

A communication system according to the fourth aspect is for a multi-input multi-output system. The communication system includes: a transmitter; and a receiver. The transmitter includes: a first antenna device configured to perform transmission using a plurality of polarized waves; and a transmitting circuit configured to divide data to be transmitted into a plurality of data streams, and transmit the data by multiplexing signals corresponding to the data streams on the plurality of polarized waves from the first antenna device. The receiver includes: a second antenna device configured to perform reception using a plurality of polarized waves; and a receiving circuit configured to receive the data by separating signals multiplexed at the transmitter from a signal received by the second antenna device via the plurality of polarized waves.

According to the communication system, a plurality of polarized waves are used for communication between a transmitter side and a receiver side. As a result, the multi-input multi-output communication with a reduced-sized antenna device can be easily realized.

What is claimed is:

1. A multi-input multi-output communication device capable of communicating with other communication device, said multi-input multi-output communication device comprising:
an antenna device configured to perform communication using a plurality of polarized waves;
a transmitting circuit configured to divide data to be transmitted into a plurality of data streams, and transmit the data by multiplexing signals corresponding to the data streams on the plurality of polarized waves from the antenna device; and
a receiving circuit configured to receive data by separating signals multiplexed at the other communication device from a signal received by the antenna device via the plurality of polarized waves.

2. The multi-input multi-output communication device according to claim 1, wherein the antenna device includes an orthogonal antenna.

3. The multi-input multi-output communication device according to claim 2, wherein the orthogonal antenna is a patch-type orthogonal antenna comprising: a plate-shaped ground plate; a plate-shaped driven element spaced by a predetermined distance from the ground plate; and power receiving and feeding terminals configured to receive and feed power and provided at different positions on phases of the driven element.

4. The multi-input multi-output communication device according to claim 3, wherein the driven element is rectangular or circular and shape.

5. The multi-input multi-output communication device according to claim 2, wherein the orthogonal antenna is a Yagi-type orthogonal antenna that comprises: a first Yagi-Uda antenna comprising a reflector element, a driven element, and a director element arranged in order from a rear end side; a second Yagi-Uda antenna that comprises a reflector element, a driven element, and a director element arranged in order from a rear end side, has the same directional direction as the first Yagi-Uda antenna and is arranged to be rotated by a predetermined angle with respect to an axis in the directional direction; and power feeding lines configured to feed power to each of the driven elements of the first and second Yagi-Uda antennas.

6. The multi-input multi-output communication device according to claim 1, wherein the receiving circuit comprises a circuit configured to separate a plurality of data streams from the received signal by multiplying the received signal by a predetermined reception weight.

7. The multi-input multi-output communication device according to claim 1, wherein the transmitting circuit and the receiving circuit perform a unique mode transfer for transmission and reception by sharing information regarding transfer paths to the other communication device.

8. The multi-input multi-output communication device according to claim 1,
wherein the transmitting circuit comprises a circuit configured to code the data in a space-time domain by pre-processing data to be multiplexed, and
wherein the receiving circuit separates the signals from the received signal using a decoding method corresponding to a coding method of the transmitting circuit.

9. The multi-input multi-output communication device according to claim 8, wherein the coding method uses one of a space-time block code (STBC) and a space-time trellis code (STTC).

10. A patch-type orthogonal antenna device for use in at least one of a terminal device and an access point in a wireless LAN for performing wireless communication in a multi-input multi-output system, said antenna device comprising:
a plate-shaped ground plate;
a plate-shaped driven element provided to be spaced by a predetermined distance from the ground plate; and
power receiving and feeding terminals configured to receive and feed power and provided at different positions on phases of the driven element.

11. A Yagi-type orthogonal antenna device for use in at least one of a terminal device and an access point in a wireless LAN for performing wireless communication in a multi-input multi-output system, said antenna device comprising:
a first Yagi-Uda antenna comprising a reflector element, a driven element, and a director element arranged in order from a rear end side;
a second Yagi-Uda antenna that comprises a reflector element, a driven element, and a director element arranged in order from a rear end side, has the same directional direction as the first Yagi-Uda antenna and is arranged to be rotated by a predetermined angle with respect to an axis in the directional direction; and
power feeding lines configured to feed power to each of the driven elements of the first and second Yagi-Uda antennas.

12. The antenna device of claim 10, wherein the reflector element, the driven element, and the director element in each of the first and second Yagi-Uda antennas are formed as conductors provided on a substrate of a predetermined dielectric constant.

13. A communication system for a multi-input multi-output system, comprising:
a transmitter; and
a receiver,
wherein the transmitter comprises:
a first antenna device configured to perform transmission using a plurality of polarized waves; and
a transmitting circuit configured to divide data to be transmitted into a plurality of data streams, and transmit the data by multiplexing signals corresponding to the data streams on the plurality of polarized waves from the first antenna device, and
wherein the receiver comprises:
a second antenna device configured to perform reception using a plurality of polarized waves; and
a receiving circuit configured to receive the data by separating signals multiplexed at the transmitter from a signal received by the second antenna device via the plurality of polarized waves.

14. The communication system according to claim 13, wherein the first and second antenna devices include orthogonal antennas.
